(19) United States
(12) Patent Application Publication
(10) Pub. No.: US 2020/0324360 A1
(43) Pub. Date: Oct. 15, 2020

(54) METHOD FOR PRODUCING STEEL PLATE MEMBER

(71) Applicant: TOYOTA JIDOSHA KABUSHIKI KAISHA, Toyota-shi (JP)

(72) Inventors: Tomoaki Ihara, Toyota-shi (JP); Shinya Yamamoto, Toyota-shi (JP)

(73) Assignee: TOYOTA JIDOSHA KABUSHIKI KAISHA, Toyota-shi (JP)

(21) Appl. No.: 16/811,769

(22) Filed: Mar. 6, 2020

(30) Foreign Application Priority Data
Apr. 15, 2019 (JP) 2019-077111

(51) Int. Cl. B23K 20/02; B21D 22/02

(52) U.S. Cl. CPC B23K 20/02; B23K 2103/04; B21D 22/02

(57) ABSTRACT

A method for producing a steel plate member according to an example aspect of the present disclosure includes heating first and second steel plates and press-forming the heated first and second steel plates while sandwiching the first and second steel plates between an upper die and a lower die and cooling the first and second steel plates. In the press-forming, end parts of the first and second steel plates are overlapped, and the overlapped end parts are pressure-welded by the press-forming.

### CROSS REFERENCE TO RELATED APPLICATIONS

This application is based upon and claims the benefit of priority from Japanese patent application No. 2019-077111, filed on Apr. 15, 2019, the disclosure of which is incorporated herein in its entirety by reference.

### BACKGROUND The present disclosure relates to a method for producing a steel plate member.

Japanese Unexamined Patent Application Publication No. 2013-066927 discloses a method for providing a cylindrical outer shape regulating fitting when steel bars are abutted against each other and pressure-welded.

### SUMMARY

The present inventors have found the following problem regarding the method for producing a steel plate member.

When the pressure welding method disclosed in Japanese Unexamined Patent Application Publication No. 2013-066927 is applied to steel plates, it is difficult to make the steel plates abut against each other and pressure-weld the steel plates, and even when an outer shape regulating fitting is provided at a pressure-welded part, undesired deformation such as buckling may occur at a part other than the pressure-welded part.

The present disclosure has been made in light of such circumstances. An object of the present disclosure is to provide a method for producing a steel plate member capable of pressure-welding a plurality of steel plates while effectively preventing deformation of a pressure-welded part and parts other than the pressure-welded part.

An example aspect is a method for producing a steel plate member including:

heating first and second steel plates; and

press-forming the heated first and second steel plates while sandwiching the first and second steel plates between an upper die and a lower die and cooling the first and second steel plates.

In the press-forming, end parts of the first and second steel plates are overlapped, and the overlapped end parts are pressure-welded by the press-forming.

In the method for producing a steel plate member according to the example aspect, in the press-forming, end parts of the first and second steel plates are overlapped, and the overlapped end parts are pressure-welded by the press-forming.

Since the steel plates are pressure-welded while being press-formed, it is possible to effectively prevent undesired deformation at a pressure-welded part and undesired deformation such as buckling at a part other than the pressure-welded part as compared with butt pressure welding.

In the press-forming, a compression rate of the overlapped end parts may be 30% or higher. Such a configuration enables more reliable pressure-welding.

A projection and a recess may be provided to at least one of the upper die and the lower die at a position where the projection and the recess are brought into contact with the overlapped end parts of the first and second steel plates. Alternatively, a projection and a recess may be provided to at least one of the overlapped end part of the first steel plate and the overlapped end part of the second steel plate. With such a configuration, an area of a contact interface between the end parts in the pressure-welded part can be increased, and the end parts can be joined more firmly.

The first and second steel plates may be made of different types of steel plates, a strength of the first steel plate after the press forming being different from a strength of the second steel after the process forming. Alternatively, a thickness of the first steel plate before the press-forming may differ from a thickness of the second steel plate after the press-forming. With such a configuration, both a high strength and excellent impact absorption characteristics can be achieved.

According to the present disclosure, it is possible to provide a method for producing a steel plate member capable of pressure-welding a plurality of steel plates while effectively preventing deformation of a pressure-welded part and parts other than the pressure-welded part.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a temperature chart showing a method for producing a steel plate member according to a first embodiment;

FIG. 2 is a perspective view showing an example of a press forming process;

FIG. 3 is a perspective view showing a specific example of the steel plate member according to the first embodiment;

FIG. 4 is a schematic perspective view showing an example of dies used in a method for producing a steel plate member according to a second embodiment;

FIG. 5 is a schematic perspective view showing another example of dies used in the method for producing a steel plate member according to the second embodiment;

FIG. 6 is a schematic perspective view showing an example of a steel plate used in a method for producing a steel plate member according to a third embodiment;

FIG. 7 is a schematic perspective view showing another example of steel plates used in the method for producing a steel plate member according to the third embodiment;

FIG. 8 is a perspective view showing a specific example of a steel plate member according to a fourth embodiment;

FIG. 9 is a schematic plan view of a steel plate 51 and a steel plate 52 before press forming;

FIG. 10 is a perspective view showing a press forming process according to an experimental example; and

FIG. 11 is a photograph of a longitudinal sectional view of a pressure-welded part of a steel plate member according to Experimental Example 9.

### DESCRIPTION OF EMBODIMENTS

Hereinafter, specific embodiments to which the present disclosure is applied will be described in detail with reference to the drawings. However, the present disclosure is not limited to the following embodiments. Further, the following descriptions and drawings are simplified as appropriate for clarity of explanation.

### First Embodiment

### <Method for Producing Steel Plate Member>

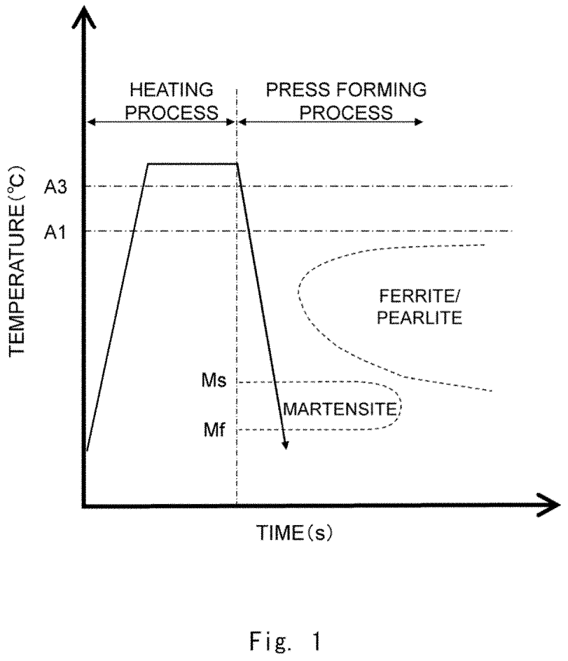

First, a method for producing a steel plate member according to the first embodiment will be described with reference to FIG. 1. The method for producing a steel plate member according to the first embodiment is suitable as a method for producing a steel plate member for automobiles that require, for example, both a high strength and excellent impact absorption characteristics. Examples of the steel plate member include a steel plate member having a hat-shaped cross section perpendicular to the longitudinal direction, such as a side member (e.g., front side member, rear floor side member) and a pillar.

FIG. 1 is a temperature chart showing a method for producing a steel plate member according to the first embodiment. In FIG. 1, the horizontal axis represents time (s), and the vertical axis represents temperature (° C.). As shown in FIG. 1, the method for producing a steel plate member according to the first embodiment includes a heating process and a press forming process.

First, the heating process shown in FIG. 1 will be described.

As shown in FIG. 1, in the heating process, a steel plate (first steel plate) 11 and a steel plate (second steel plate) 12 are heated using, for example, a general-purpose heating furnace. The entire steel plates 11 and 12 are heated to a temperature higher than, for example, an austenite transformation completion temperature A3, although the heating temperature of the steel plates 11 and 12 are not limited in particular. In this case, during the heating process, the microstructures of the entire steel plates 11 and 12 change from ferrite and pearlite to an austenite single phase.

In FIG. 1, an austenite transformation start temperature A1 is also shown.

The steel plates 11 and 12 are steel plates for hot stamping made of, for example, manganese boron steel having a thickness of about 1 to 4 mm, although the steel plates 11 and 12 are not limited in particular. The flat steel plates 11 and 12 before the heating process are, for example, soft materials including microstructures formed of ferrite and pearlite. Furthermore, by using different types of steel plates having a tensile strength after the press forming process different from each other as the steel plates 11 and 12, both a high strength and excellent impact absorption characteristics can be achieved. For example, the difference between a tensile strength of the steel plate 11 and that of the steel plate 12 is set to 500 MPa or greater.

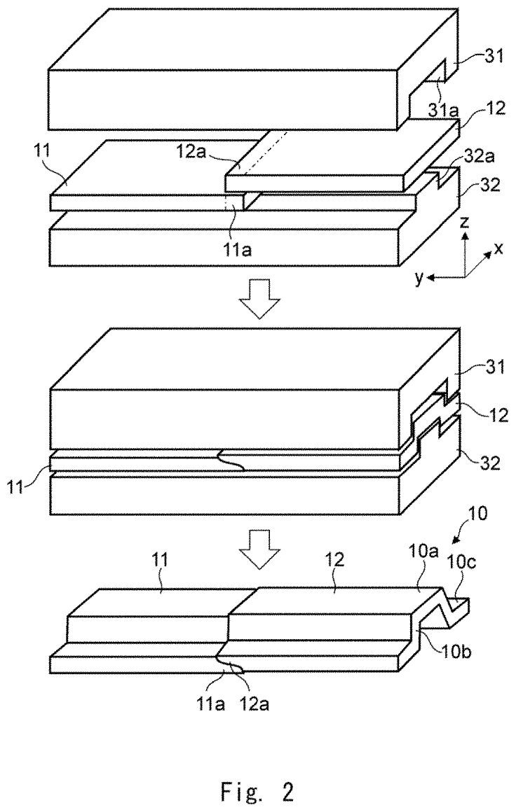

Next, the press forming process shown in FIG. 1 will be described. FIG. 2 is a perspective view showing an example of the press forming process. As shown in FIG. 2, in the press forming process, the heated steel plates 11 and 12 are sandwiched between an upper die 31 and a lower die 32 and cooled while being press formed. Since this press-forming is hot press forming, the steel plates 11 and 12 are quenched by the dies (upper die 31 and lower die 32) while avoiding the springback that occurs during cold press forming, thereby obtaining a high strength steel plate member. Such hot press forming is commonly referred to as hot stamping.

The right-handed xyz orthogonal coordinates shown in FIG. 2 and other drawings are for convenience to describe the positional relationship of the components, as a matter of course. Commonly, a z-axis positive direction is vertically upward, and an xy plane is a horizontal plane.

In the example of FIG. 2, as shown in the upper part of FIG. 2, when the heated steel plates 11 and 12 are placed on the upper die 31, an end part 11a of the steel plate 11 on a y-axis negative direction side is overlapped with an end part 12a of the steel plate 12 on a y-axis positive direction side. When the overlapped amount (overlapped margin) is too large, a compression rate required for the pressure welding cannot be achieved in the press forming, which disables the pressure-welding. On the other hand, when the overlapped margin is too small, the strength of the pressure-welded part becomes insufficient. The overlapped margin is, for example, about 2 to 10 mm.

As shown in the middle part of FIG. 2, when the thicknesses of the steel plates 11 and 12 are the same, the end part 11a of the steel plate 11 and the end part 12a of the steel plate 12 are compressed to substantially half the thickness during the press forming. Thus, the area of the contact interface between the end part 11a and the end part 12a of the steel plate 12 is approximately doubled, and the steel plates 11 and 12 are pressure-welded at the end parts 11a and 12a. As a result, as shown in the lower part of FIG. 2, the steel plate member 10 according to the first embodiment is produced.

The compression rate for pressure-welding the overlapped end parts 11a and 12a may be, for example, 30% or higher. Here, the formula “compression rate(%)=(plate thickness of pressure-welded part before press forming−plate thickness of pressure-welded part after press forming)/plate thickness of pressure-welded part before press forming×100” holds. When the steel plates 11 and 12 have the same thickness, an ideal value of the compression rate is 50%.

Here, in the press forming process shown in the temperature chart of FIG. 1, a martensite transformation start temperature Ms, a martensite transformation end temperature Mf, and a ferrite/pearlite nose in a CCT (Continuous Cooling Transformation) diagram are schematically shown. As shown in FIG. 1, when the steel plates 11 and 12 are brought into contact with the upper die 31 and the lower die 32, they are cooled at a cooling rate faster than an upper critical cooling rate. Thus, the steel plates 11 and 12 are transformed into martensite, and the steel plates 11 and 12, i.e., the entire microstructure of the steel plate member 10, are changed into martensite.

In this manner, by overlapping the end parts 11a and 12a of the steel plates 11 and 12 and then press-forming the end parts 11a and 12a of the steel plates 11 and 12, the steel plates 11 and 12 can be pressure-welded while being formed. In other words, the steel plates 11 and 12 can be pressure-welded and press formed at the same time during the press forming process. It is therefore not necessary to provide a pressure welding process and a pressure welding apparatus separately from a process and an apparatus for the press forming.

Further, since the steel plates are pressure-welded while being press-formed, it is possible to effectively prevent undesired deformation at a pressure-welded part and undesired deformation such as buckling at a part other than the pressure-welded part as compared with butt pressure welding.

The steel plate member 10 shown in the lower part of FIG. 2 has a hat-shaped cross section including a top plate 10a, side walls 10b, and flange parts 10c extending in a y-axis direction. More specifically, the pair of side walls 10b are formed downward from end parts of the top plate 10a in the width direction (x-axis direction) extending in the y-axis direction. Further, each of the flange parts 10c projects outward from a lower end part (z-axis negative direction side) of the corresponding side wall 10b.

Thus, as shown in FIG. 2, a recess 31a that is recessed in a rectangular cross section is provided on a lower surface of the upper die 31 so as to extend in an axial direction (y-axis direction). Likewise, a projection 32a having a rectangular cross section is provided on an upper surface of the lower die 32 so as to extend in the axial direction (y-axis direction).

As described above, in the method for producing a steel plate member according to this embodiment, the steel plates 11 and 12 can be pressure-welded while being formed by overlapping the end parts 11a and 12a of the steel plates 11 and 12 and press-forming them. It is therefore not necessary to provide a pressure welding process and a pressure welding apparatus separately from a process and an apparatus for the press forming. Furthermore, since the steel plates are pressure-welded while being press-formed, it is possible to effectively prevent undesired deformation at a pressure-welded part and undesired deformation such as buckling at a part other than the pressure-welded part as compared with butt pressure welding.

### <Specific Examples of Steel Plate Members>

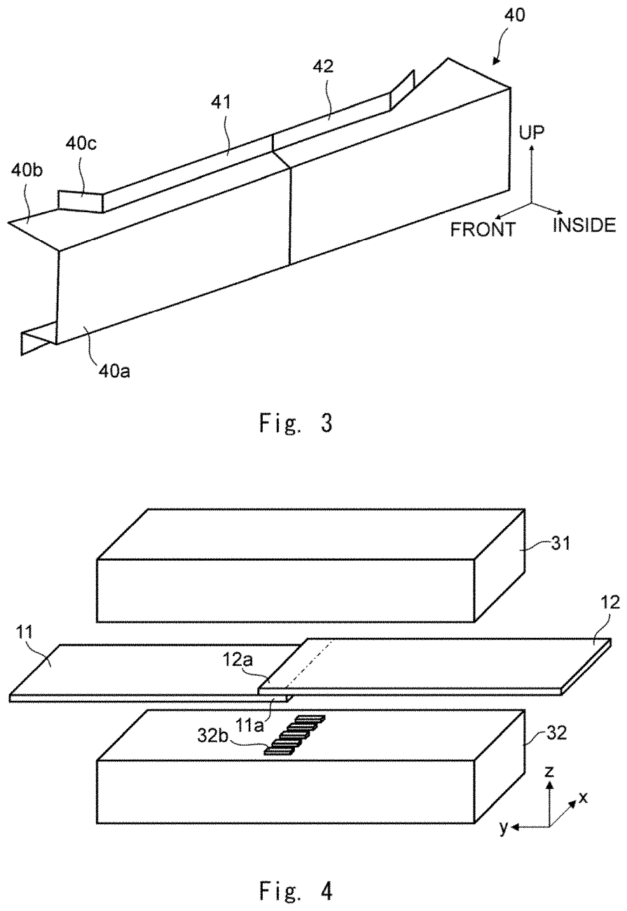

Next, a configuration of a specific example of the steel plate member according to the first embodiment will be described with reference to FIG. 3. FIG. 3 is a perspective view of a specific example of the steel plate member according to the first embodiment. The steel plate member according to the specific example is produced using the method for producing a steel plate member according to the first embodiment. A steel plate member 40 shown in FIG. 3 is an example of a front side member inner that is a vehicle member. The arrows shown in FIG. 3 indicate the directions of the vehicle.

Note that the use and shape of the steel plate member 40 shown in FIG. 3 are merely examples, and the use and shape of the steel plate member according to this embodiment are not limited at all.

The steel plate member 40 shown in FIG. 3 has a hat-shaped cross section including a top plate 40a, side walls 40b, and flange parts 40c extending in a front-rear direction. More specifically, the pair of side walls 40b are formed outward from end parts of the top plate 40a in the width direction extending in the front-rear direction. Further, each of the flange parts 40c projects outward (i.e., upper side or lower side of FIG. 3) from an end part of the corresponding side wall 40b.

In a manner similar to the steel plate member 10 shown in FIG. 2, in the steel plate member 40 shown in FIG. 3, a rear side end part of the steel plate 41 and a front side end part of the steel plate 42 are pressure-welded at the center in the front-rear direction by press forming. For example, the front steel plate 41 has a low strength and an excellent impact absorption property, while the rear steel plate 42 has a high strength. With such a configuration, both a high strength and excellent impact absorption characteristics can be achieved.

### Second Embodiment

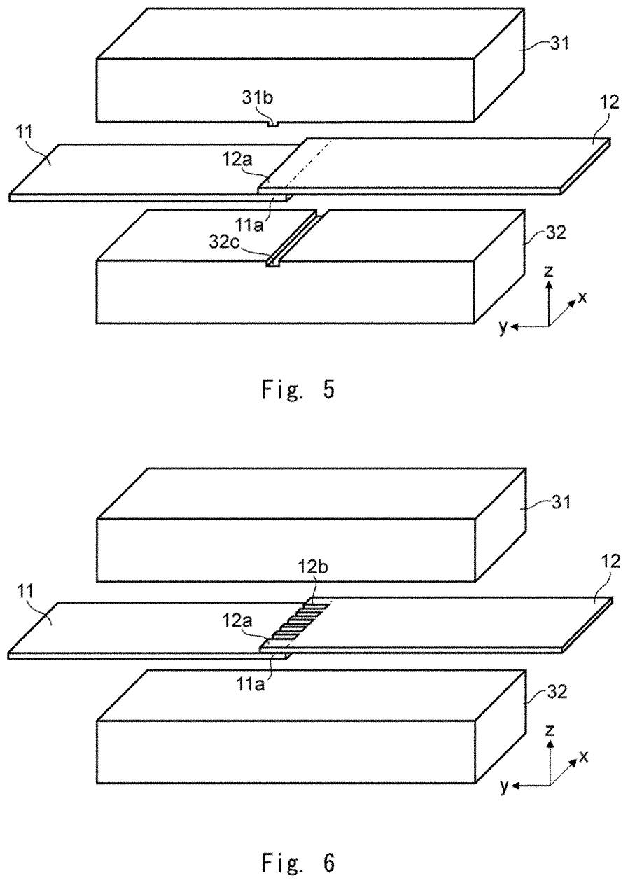

Next, a method for producing a steel plate member according to the second embodiment will be described with reference to FIGS. 4 and 5. FIG. 4 is a schematic perspective view showing an example of dies used in the method for producing a steel plate member according to the second embodiment. FIG. 5 is a schematic perspective view showing another example of dies used in the method for producing a steel plate member according to the second embodiment. As shown in FIGS. 4 and 5, in this embodiment, projections and a recess are provided at positions that are brought into contact with the overlapped end part 11a of the steel plate 11 and the overlapped end part 12a of the steel plate 12 in at least one of the upper die 31 and the lower die 32.

In the example shown in FIG. 4, a plurality of rectangular parallelepiped projections 32b extending in the longitudinal direction are arranged side by side in the width direction (x-axis direction) at the center of the lower die 32 in the longitudinal direction (y-axis direction). Therefore, when the end parts 11a and 12a of the overlapped steel plates 11 and 12 are pressure-welded by the press forming, a recess corresponding to the projection 32b is formed in the pressure-welded part. As a result, the area of the contact interface between the end parts 11a and 12a in the pressure-welded part can be increased, and the end parts 11a and 12a can be joined more firmly.

In the example shown in FIG. 5, a projection 31b having a rectangular cross section extending in the entire width direction (x-axis direction) is provided at the center of the upper die 31. Further, a groove 32c having a rectangular cross section extending in the entire width direction (x-axis direction) is provided at the center of the lower die 32. The projection 31b and the groove 32c are arranged to face each other. Thus, when the end parts 11a and 12a of the overlapped steel plates 11 and 12 are pressure-welded by press forming, the pressure-welded part is swagged in a U shape in a yz section by the projection 31b and the groove 32c.

Thus, the area of the contact interface between the end parts 11a and 12a in the pressure-welded part can be increased, and the end parts 11a and 12a can be joined more firmly.

### Third Embodiment

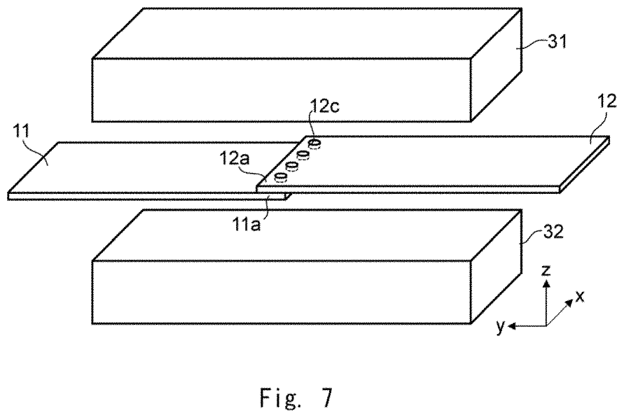

Next, a method for producing a steel plate member according to a third embodiment will be described with reference to FIGS. 6 and 7. FIG. 6 is a schematic perspective view showing an example of a steel plate used in the method for producing a steel plate member according to the third embodiment. FIG. 7 is a schematic perspective view showing another example of steel plates used in the method for producing a steel plate member according to the third embodiment. As shown in FIGS. 6 and 7, in this embodiment, projections and recesses are provided in at least one of the end part 11a of the overlapped steel plates 11 and the end part 12a of the steel plates 12.

In the example shown in FIG. 6, a plurality of cutout parts 12b extending in the longitudinal direction (y-axis direction) are provided in the end part 12a of the steel plate 12 side by side in the width direction (x-axis direction). In other words, the end part 12a of the steel plate 12 is formed in a comb shape. Therefore, when the end parts 11a and 12a of the overlapped steel plates 11 and 12 are pressure-welded by the press forming, the end part 11a of the steel plate 11 enters the cutout part 12b provided in the end part 12a of the steel plate 12. As a result, the area of the contact interface between the end parts 11a and 12a in the pressure-welded part can be increased, and the end parts 11a and 12a can be joined more firmly.

In the example shown in FIG. 7, a plurality of through-holes 12c are provided in the end part 12a of the steel plate 12 side by side in the width direction (x-axis direction). Thus, when the end parts 11a and 12a of the overlapped steel plates 11 and 12 are pressure-welded by the press forming, the end part 11a of the steel plate 11 enters the through-holes 12c provided in the end part 12a of the steel plate 12. As a result, the area of the contact interface between the end parts 11a and 12a in the pressure-welded part can be increased, and the end parts 11a and 12a can be joined more firmly.

### Fourth Embodiment

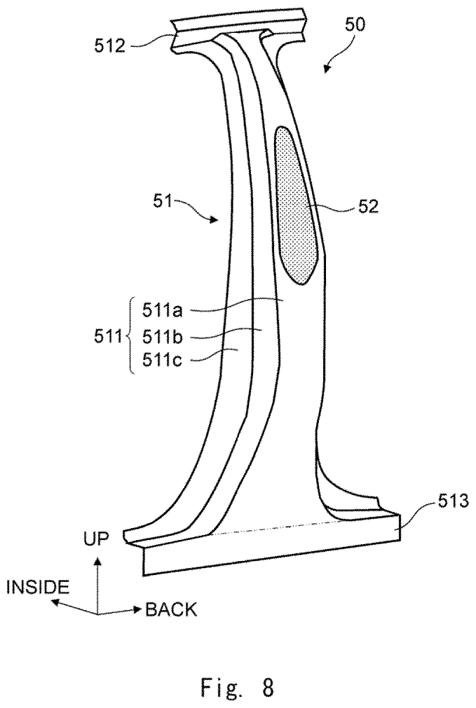

Next, a configuration of a specific example of the steel plate member according to a fourth embodiment will be described with reference to FIG. 8. FIG. 8 is a perspective view of a specific example of the steel plate member according to the fourth embodiment. The steel plate member according to the fourth embodiment is produced using a method for producing a steel plate member according to the fourth embodiment. A steel plate member 50 shown in FIG. 8 is a steel plate member for pillars that are vehicle members, more specifically, center pillar reinforcement. The arrows shown in FIG. 8 indicate the directions of the vehicle.

Note that the use and shape of the steel plate member 50 shown in FIG. 8 are merely examples, and the use and shape of the steel plate member according to this embodiment are not limited at all.

As shown in FIG. 8, the steel plate member 50 according to the fourth embodiment includes a main body part 511, an upper flange part 512, and a lower flange part 513.

As shown in FIG. 8, the main body part 511 is a section having a hat-shaped cross section including a top plate 511a, side walls 511b, and flange parts 511c extending in a vertical direction. More specifically, the pair of side walls 511b are formed inward from end parts of the top plate 511a in the width direction extending in the vertical direction. Further, each of the flange parts 511c projects outward from the end part of the corresponding side wall 511b.

The main body 511 is slightly curved as a whole so as to project outward.

Furthermore, an upper end part and a lower end part of the main body 511 are formed in a T shape in a plan view extending in the width direction (front-rear direction). Here, the lower end part is extended in the width direction (front-rear direction) to be wider than the upper end part.

The upper flange part 512 includes a plate surface that rises outward from an upper end part of the main body part 511, and a plate surface that projects upward from an outer end part of the other surface (outward in longitudinal direction of main body part 511). That is, the upper flange part 512 is a part having an L-shaped cross section that extends in the width direction (front-rear direction).

The lower flange part 513 is a flat part projecting to be extended from a lower end part of the top plate 511a to a lower side (outer side in longitudinal direction and also extending in the width direction (front-rear direction).

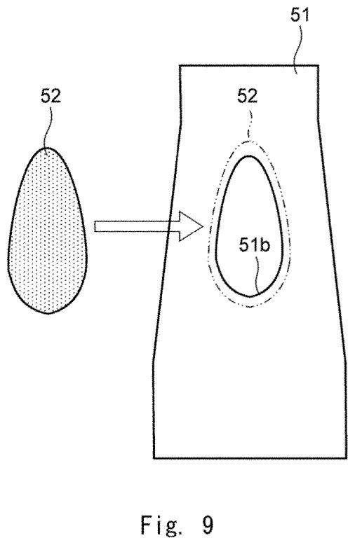

In the steel plate member 50 shown in FIG. 8, a steel plate 51 and a steel plate 52 are pressure-welded by the press forming. FIG. 9 is a schematic plan view of the steel plate 51 and the steel plate 52 before the press forming. As shown in FIG. 9, a peripheral edge of an opening 51b (inner peripheral end part of the steel plate 51) formed at the center of the steel plate 51 in the width direction and an outer peripheral end part of the steel plate 52 are overlapped. Then, at the time of the press forming, the peripheral edge of the opening 51b and the outer peripheral end part of the steel plate 52 are pressure-welded.

As shown in FIG. 8, the steel plate 52 is provided in the upper part of the top plate 511a. The material of the steel plate 52 has a strength higher than that of the steel plate 51 or the steel plate 52 is thicker than the steel late 51. With such a configuration, the strength of a part of the steel plate member 50 that requires high proof stress can be increased. Further, in the steel plate member 50 shown in FIG. 8, the steel plate 51 is reinforced by pressure-welding the steel plate 52 having a high strength to the opening 51b of the steel plate 51. By doing so, the cross-sectional efficiency is improved as compared with the method in which two steel plates are overlapped and reinforced, thereby reducing the weight of the steel plate member 50.

### EXPERIMENTAL EXAMPLE

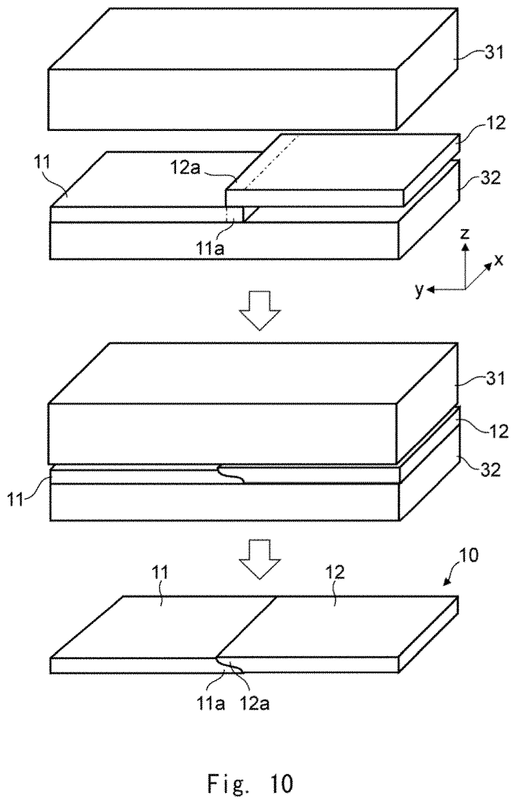

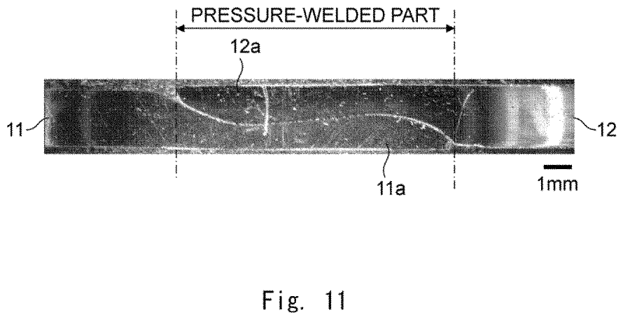

Hereinafter, experimental examples of the method for producing a steel plate member according to the embodiments will be described. FIG. 10 is a perspective view showing a press forming process according to the experimental examples. Table 1 shows a summary of the experimental conditions of Experimental Examples 1 to 11.

TABLE 1

| | Steel Plate | Steel Plate | Overlapped | | Press | Compression | Joined |
|---|---|---|---|---|---|---|---|
| | 11 | 12 | Allowance | | Load | Rate | or not |
| Experimental | Non-plated | AlSi plated | 20 | mm | 100 t | 20% | No |
| Example 1 | low strength | high strength | | | | | |
| | material | material | | | | | |
| Experimental | Non-plated | Non-plated | 20 | mm | 100 t | 20% | No |
| Example 2 | low strength | high strength | | | | | |
| | material | material | | | | | |
| Experimental | Non-plated | AlSi plated | 10 | mm | 100 t | 31% | Yes |
| Example 3 | low strength | high strength | | | | | |
| | material | material | | | | | |
| Experimental | AlSi plated | AlSi plated | 10 | mm | 100 t | 33% | Yes |
| Example 4 | low strength | high strength | | | | | |
| | material | material | | | | | |
| Experimental | Non-plated | AlSi plated | 10 | mm | 200 t | 40% | Yes |
| Example 5 | low strength | high strength | | | | | |
| | material | material | | | | | |
| Experimental | AlSi plated | AlSi plated | 10 | mm | 200 t | 38% | Yes |
| Example 6 | low strength | high strength | | | | | |
| | material | material | | | | | |
| Experimental | Non-plated | AlSi plated | 5 | mm | 100 t | 38% | Yes |
| Example 7 | low strength | high strength | | | | | |
| | material | material | | | | | |
| Experimental | AlSi plated | AlSi plated | 5 | mm | 100 t | 40% | Yes |
| Example 8 | low strength | high strength | | | | | |
| | material | material | | | | | |
| Experimental | Non-plated | AlSi plated | 5 | mm | 200 t | 48% | Yes |
| Example 9 | low strength | high strength | | | | | |
| | material | material | | | | | |
| Experimental | AlSi plated | AlSi plated | 5 | mm | 200 t | 45% | Yes |
| Example 10 | low strength | high strength | | | | | |
| | material | material | | | | | |
| Experimental | AlSi plated | AlSi plated | 5 | mm | 200 t | 29% | No |
| Example 11 | high strength | high strength | | | | | |
| | material | material | | | | | |

First, the steel plates 11 and 12 having a thickness of 2.0 mm and a width of 40 mm were held at 900° C. for 6 minutes to make the entire steel plates austenitic. After that, as shown in FIG. 10, the end parts 11a and 12a of the steel plates 11 and 12 were overlapped, placed on the lower die 32, and press-formed while being quenched between the lower die 32 and the upper die 31. It was determined whether the steel plates 11 and 12 were joined in the plate-shaped steel plate member 10 produced in this manner.

As shown in Table 1, regarding the Experimental Examples 1 to 11, it was determined whether the steel plates 11 and 12 were joined under different conditions, with different types of the steel plates 11 and 12, plated plates or non-plated plates, different overlapped margins, and different press loads. Moreover, a compression rate was measured in each Experiment Example. As the types of steel, SPH steel or SA1D steel with a tensile strength before quenching of about 270 MPa was used for the low strength material, and manganese boron steel (22MnB5) with a tensile strength after quenching of about 1.5 GPa was used for the high strength material. For the condition of using plated plates or non-plated plates, an Al-Si-based plated steel plate or a non-plated steel plate was used.

As shown in Table 1, for the steel plates 11 according to the Experimental Examples 1 to 10, plated or non-plated low strength materials were used. For the steel plate 11 according to Experimental Example 11, a high strength material of an Al-Si-based plated steel plate was used. For the steel plate 12, in all the Experimental Examples 1 to 11, a high strength material of an Al-Si-based plated steel plate was used.

The overlapped margin was changed in three stages of 5 mm, 10 mm, and 20 mm. The press load was 100 t or 200 t. The compression rate was obtained by a formula “compression rate (%)=(plate thickness of pressure-welded part before press forming−plate thickness of pressure-welded part after press forming)/plate thickness of pressure-welded part before press forming×100”. The “plate thickness of pressure-welded part before press forming” and “plate thickness of pressure-welded part after press forming” were measured using a micrometer.

From the results of Experimental Examples 1 to 10 in Table 1, it has been found that the smaller the overlapped margin and the greater the press load, the compression rate is increased, regardless of the use of the plated steel plate or non-plated steel plate. From the result of comparison between Experimental Examples 11 and Experimental Examples 9 and 10, it has been found that the smaller the tensile strength of the steel plates, the compression rate becomes higher. As shown in Table 1, the steel plates were joined to each other in Experimental Examples 3 to 10 in which the compression rate was 30% or higher. When tensile tests were conducted in Experimental Examples 3 to 10, in Experimental Examples 3 to 9, a fracture occurred in the base material, not in the joining interface, and in Example 10, a peeling occurred in the joining interface.

On the other hand, in Experimental Examples 1, 2, and 11 in which the compression rate was less than 30%, the steel plates were not joined to each other.

FIG. 11 is a photograph of a longitudinal cross-sectional view of the pressure-welded part of the steel plate member according to Experimental Example 9 in which the compression rate was the maximum at 48%. As shown in FIG. 11, the plate thickness of the pressure-welded part is compressed to become equal to the plate thickness of the steel plates 11 and 12, and the end parts 11a and 12a of the steel plates 11 and 12 are sufficiently stretched. That is, the contact interface between the end parts 11a and 12a is sufficiently expanded by press forming.

From the results of Experimental Examples 1 to 11 shown above, it has been found that when the overlapped margin, press load, and the like are adjusted in such a way that the compression rate of the pressure-welded part are increased to some extent, the steel plates can be pressure-welded by overlapping and press forming the end parts of the steel plates. Since the steel plates are pressure welded while being press-formed, it is not necessary to provide a pressure welding process and a pressure welding apparatus separately from a process and an apparatus for the press forming. Further, as compared with butt pressure welding, it is possible to effectively prevent undesired deformation at a pressure-welded part and undesired deformation such as buckling at a part other than the pressure-welded part.

Note that the present disclosure is not limited to the above embodiments, modifications may be made as appropriate within a range not departing from the scope of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A method for producing a steel plate member comprising:
heating first and second steel plates; and
press-forming the heated first and second steel plates while sandwiching the first and second steel plates between an upper die and a lower die and cooling the first and second steel plates, wherein
in the press-forming, end parts of the first and second steel plates are overlapped, and the overlapped end parts are pressure-welded by the press-forming.

2. The method according to claim 1, wherein
in the press-forming, a compression rate of the overlapped end parts is 30% or higher.

3. The method according to claim 1, wherein
a projection and a recess are provided to at least one of the upper die and the lower die at a position where the projection and the recess are brought into contact with the overlapped end parts of the first and second steel plates.

4. The method according to claim 1, wherein
a projection and a recess are provided to at least one of the overlapped end part of the first steel plate and the overlapped end part of the second steel plate.

5. The method according to claim 1, wherein
the first and second steel plates are made of different types of steel plates, a strength of the first steel plate after the press forming being different from a strength of the second steel after the process forming.

6. The method according to claim 1, wherein
a thickness of the first steel plate before the press-forming differs from a thickness of the second steel plate after the press-forming.
